(19) United States
(12) Patent Application Publication
(10) Pub. No.: US 2008/0183768 A1
(43) Pub. Date: Jul. 31, 2008

(54) SYSTEM, METHOD AND PROGRAM FOR MONITORING LOCAL MAIL REPLICAS AND LOCAL DIRECTORY REPLICAS FOR E-MAIL

(75) Inventors: Paul Gerard Bucher, Wappingers Falls, NY (US); Kathleen Andersson Burchfield, Woodstock, NY (US); Thomas A. Gallacher, Hopewell Junction, NY (US); Matthew Aloyisuis McCarthy, Holly Springs, NC (US); Jeffrey R. Scutt, Suwanee, GA (US)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 11/627,615

(22) Filed: Jan. 26, 2007

(51) Int. Cl. G06F 17/30

(52) U.S. Cl. 707/201; 707/E17.009

(57) ABSTRACT

System, method and program for monitoring use of a local file replica in a client computer. First program instructions read a log which records a date and/or time of last replication of the local file replica from a remote file server. Second program instructions compare the date and/or time of last replication of the local file replica to a predetermined time window. Third program instructions are responsive to the date and/or time of last replication of the local file replica being within the predetermined time window to determine and report that local file replication is currently in use. The third program instructions are also responsive to the date and/or time of last replication of the local file replica being outside the predetermined time window to determine and report that local file replication is not currently in use.

### FIELD OF THE INVENTION

The invention relates generally to computer systems and electronic mail, and more specifically to monitoring use of local mail replicas and local directory replicas within electronic mail systems.

### BACKGROUND OF THE INVENTION

Electronic mail or “e-mail” is well known today. A user at a client workstation can generate an e-mail, identify an addressee by user ID, and make a selection on the workstation to send the e-mail to the addressee. In response, the workstation sends the e-mail to a mail server for the user. The mail server for the user/originator queries a domain name server to identify a mail server for the addressee, and then forwards the e-mail to the mail server for the addressee. In response, the mail server for addressee notifies the addressee of the incoming e-mail. In response, the addressee can request the e-mail from the addressee's mail server. In this mode of operation, each e-mail that is generated and selected for sending by the originator is sent promptly and individually to the mail server of the originator, sent promptly and individually from the mail server of the originator to the mail server of the addressee, and sent promptly and individually from the mail server of the addressee to the addressee's workstation. One problem with this mode of operation is that it is burdensome for each mail server to individually receive, process and forward each e-mail. It is more efficient for the mail server of the user to receive e-mail from the user in batches, i.e. groups of e-mails from the user during a predetermined time interval. Likewise, it is more efficient for the mail server of the addressee to notify and make available to the addressee a batch of e-mails addressed to each addressee and received by the mail server within a predetermined time interval.

The originator of the e-mail and the addressee of the e-mail may access their e-mail directly and dynamically from their respective mail server. Consequently, if their respective mail server is not available, then they cannot read previously sent mail or prepare responses to previously sent mail.

A known IBM Lotus Notes™ e-mail system provides an option where a client workstation maintains a “local mail replica” for incoming and outgoing mail. A local mail replica includes a copy of incoming mail that has actually been received by the client workstation. The client workstation periodically (for example, every five minutes) requests from its mail server new incoming mail which has been stored at its mail server pending the next request. The local mail replica also includes a copy of outgoing mail that has been generated by a user at the client workstation and designated by the user at the client workstation for sending to an addressee, although not necessarily sent yet to the client workstation mail server or received by the addressee. In other words, with the local mail replica option selected, when a user generates an e-mail and selects a “send” function, the e-mail is not immediately sent to the user's mail server. Rather, the e-mail is held at the user's workstation until lapse of a periodic timer (for example, a five minute timer). During each such period, all e-mails originating at the user's workstation are batched at the user's workstation. Nevertheless, as soon as the originator selects the send function, the originator's workstation will indicate mail that has been sent. Upon lapse of the periodic timer, the user's/originator's workstation sends the batch of e-mails to the user's/originator's mail server.

The batching of incoming and outgoing e-mails improves the efficiency of the originator's mail server and use of the network between the originator's workstation and the originator's mail server. Likewise, the workstation of the addressee can operate in a local mail replica/batched mode, where the workstation of the addressee periodically requests notification of incoming e-mails sent to the addressee. In the local replica/batched mode, the addressee's workstation does not directly access a copy of the incoming mail as stored on its mail server, and the addressee's mail server does not automatically notify the addressee's workstation or forward every e-mail addressed to the addressee's workstation upon receipt of the e-mail by the addressee's mail server. Upon the periodic request by the addressee's workstation, the addressee's mail server forwards a list of incoming e-mails addressed to the addressee and received by the mail server since the last update. Upon receipt of the list, the addressee can “open” any of the e-mails to read its contents. This improves the efficiency of the mail server for the addressee. In the foregoing scenario, both workstations are said to utilize a “local mail replica” because both workstations access a local copy of their incoming and outgoing mail, the list of incoming mail is updated periodically and the outgoing mail is actually sent periodically.

In addition to the improvement in efficiency of the mail servers and the networks between the originator workstation and the addressee's workstation, if either mail server fails or the network connections to their mail server fails, the user can still access the user's local mail copy, even though the local mail copy will not be updated until access to the mail server is restored. The drawback of the local mail replica mode and its periodic update is that incoming mail is not received promptly, and outgoing mail from an originator is not sent promptly to the addressee. Also, even when outgoing mail is received by the mail server of the addressee, the mail server of the addressee does not immediately notify the addressee of the incoming mail. On balance, most employers and e-mail service companies want their users to utilize a local mail replica, with a reasonable period of update. Typically, the users have an option whether to use a local mail replica or access their mail server's copy directly. A user profile indicates the location of a mail replica file, but does not indicate if replication is enabled. It is possible for a local mail replica to exist in the client workstation, but not be in use because the user disabled the local mail replica after it was used for some time, or because of some other problem with the client e-mail program.

The IBM Lotus Notes e-mail system assists an originator of an e-mail in completing the address of an addressee when the address is listed in a directory and the originator supplies a distinguishing or significant part of the e-mail address of the addressee. For example, the directory contains the following intra company e-mail address: “Thomas Robert Jones/Rochester/IBM@IBMUS”. If the originator of the e-mail enters “Thomas Robert Jo”, then the Lotus Notes e-mail system may determine from the directory that there is only one addressee which begins “Thomas Robert Jo”, and in response, automatically complete the address for the e-mail, i.e. automatically add “nes/Rochester/IBM@IBMUS” to what was entered by the originator. This assists the originator in entering the address, and also confirms to the originator that this address is valid. The Lotus Notes e-mail system can also complete an address (entered in part by the originator of the e-mail) when there are two or more possible endings, by selecting the address that has been used recently by the originator or in a short names list, but permit the originator to overwrite it if incorrect. The Lotus Notes e-mail system can also suggest in a pull-down menu two or more possible e-mail addresses that correspond to what the originator entered, and permit the originator to select the correct one. At which time, the Lotus Notes e-mail system will enter the complete e-mail address in the address field. In all the foregoing scenarios, the Lotus Notes client e-mail program needs access to the directory, either from a local directory replica or by query to its remote mail server. If the user of the client workstation has enabled the local directory replica option and it is working, then the client workstation periodically (for example, every hour) requests from its mail server updates to its local directory replica, and the mail server downloads the updates. In response, the client e-mail program updates its local directory replica and also notes the date/time of update in a log. If the user of the client workstation has not enabled the local directory replica option or the local directory replica option is enabled, but not working (i.e. not replicating), then the client e-mail program must query the mail server for the directory information as noted above. However, if the mail server is down or the network connection to the mail server is down, then the client e-mail program cannot assist the originator of an e-mail in completing an e-mail address or confirm that an e-mail address entered by the originator is valid. It is possible for a local directory replica to exist in the client workstation, but not be in use because the user disabled the local directory replica after it was used for some time, or because of some other problem with the client e-mail program. A user profile indicates the location of a directory replica file, but does not indicate if replication is enabled.

An object of the present invention is to automatically determine which users are using a local mail replica and/or a local directory replica, determine whether the replicas are being updated, and to take corrective action when the users are not using the local mail replica and/or a local directory replica, or the replicas are not being updated.

### SUMMARY OF THE INVENTION

The present invention resides in a system, method and program for monitoring use of a local mail replica in a client computer. First program instructions read a log which records a date and/or time of last replication of the local mail replica from a remote mail server. Second program instructions compare the date and/or time of last replication of the local mail replica to a predetermined time window. Third program instructions are responsive to the date and/or time of last replication of the local mail replica being within the predetermined time window to determine and report that local mail replication is currently in use. The third program instructions are also responsive to the date and/or time of last replication of the local mail replica being outside the predetermined time window to determine and report that local mail replication is not currently in use.

According to a feature of the present invention, replication of the local mail replica does not occur while the client computer is turned-off even if replication is enabled. The third program instructions determine how long the client computer has been turned-on, and is responsive to the date and/or time of last replication of the local mail replica being outside the predetermined time window, to not determine or report that local mail replication is not currently in use or report that local mail replication is indeterminate.

The present invention also applies to monitoring use of local replica copies of other types of files, such as a local directory replica.

### BRIEF DESCRIPTION OF THE FIGURES

FIG. 1 is a block diagram of a distributed computer system which includes a agent monitoring program in a monitored computer and a management program in a management computer, according to the present invention.

FIGS. 2(A) and 2(B) form a flow chart of the agent monitoring program of FIG. 1.

FIG. 3 is a flow chart of the management program of FIG. 1.

FIGS. 4(A) and 4(B) form a flow chart of another embodiment of the agent monitoring program of FIG. 1.

### DETAILED DESCRIPTION OF THE PREFERRED EMBODIMENTS

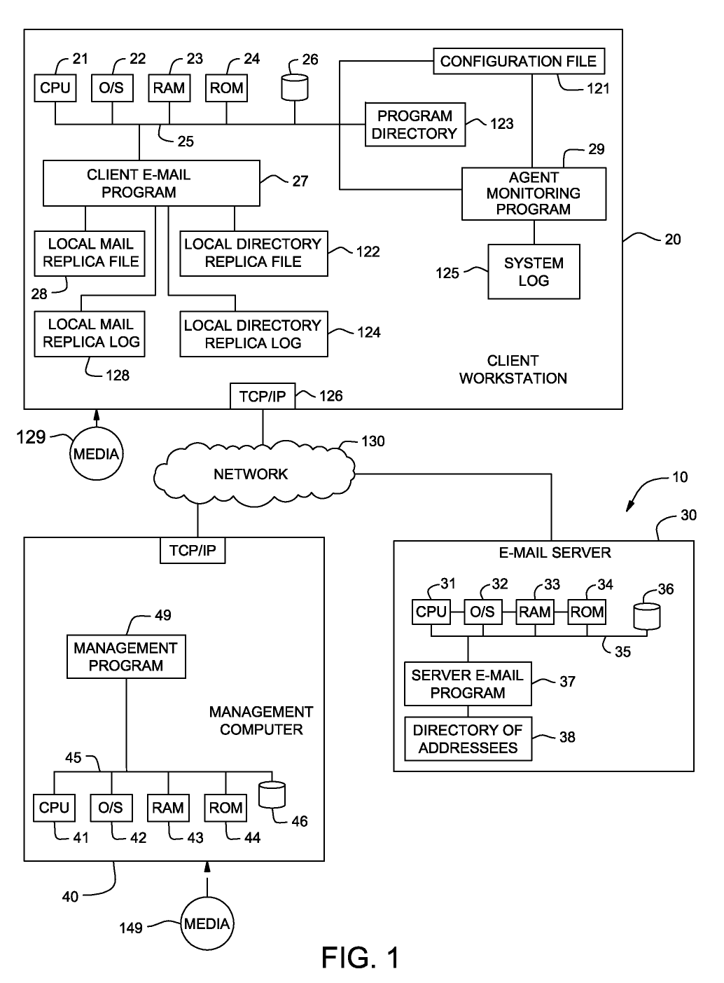

The present invention will now be described in detail with reference to the figures. FIG. 1 illustrates a distributed computer system generally designated 10 which includes the present invention. System 10 includes a monitored computer 20 (typically, a user's workstation), a mail server 30, and a management computer 40 interconnected by a network 130 such as the Internet. Monitored computer 20 includes a known CPU 21, operating system 22, RAM 23 and ROM 24 on a common bus 25 and a storage 26. Mail server 30 includes a known CPU 31, operating system 32, RAM 33 and ROM 34 on a common bus 35 and a storage 36. Management computer 40 includes a known CPU 41, operating system 42, RAM 43 and ROM 44 on a common bus 45 and a storage 46.

A known client e-mail program 27, such as IBM Lotus Notes client e-mail program, executes in workstation 20. A known server e-mail program 37, such as IBM Lotus Notes server e-mail program, executes in mail server 30. The client e-mail program 27 allows the user of workstation 20 to operate from a local mail replica of the user's incoming and outgoing e-mail stored on workstation 20 (with periodic replication of the local mail replica from the mail server 30). In the local replica mode, periodically (for example, every five minutes), the workstation 20 requests from mail server 30 all incoming mail addressed to a current user of workstation 20 received by the mail server 30 since the last period. Upon receipt of the new incoming mail, the workstation 20 updates in the local mail replica the list of incoming mail for the user, and allows the user to “open” any of the new incoming mail (as well as the old incoming mail). Also in the local replica mode, periodically (for example, every five minutes), the workstation 20 sends to mail server 30 all outgoing mail “sent” by the user of workstation 20 since the last period. Even though the outgoing mail was not actually sent from the workstation 20 to mail server 30 until this next period, the outgoing mail is nevertheless listed in the user's list of “sent mail” when the user selects the “send” button. Upon receipt of the outgoing e-mail at this next period, for each outgoing e-mail the mail server 30 identifies from a domain name server, the mail server of each addressee of the outgoing e-mail, and then forwards the e-mail to the mail server(s) of the e-mail's addressee(s). This batching of the incoming e-mails and outgoing e-mails improves the efficiency of the mail servers and optimizes use of network bandwidth. In addition to the improvement in efficiency of the mail servers and network infrastructure, if a user's mail server fails or the network connection to the user's mail server fails, the user can still access the user's local mail copy, read e-mail previously forwarded to the user's workstation and generate responses to such e-mail, even though such responses will not be forwarded to the mail server 30 until access to the mail server 30 is restored and the local mail is replicated. The drawback of the local mail replica mode and its periodic update is that outgoing mail from an originator is not sent immediately to the addressee, and incoming mail is not immediately available to the user. In the Lotus Notes e-mail client program, the user also has an option to manually request update of his or her local mail replica by selecting a replicate “button” with a mouse cursor. In response, workstation 20 sends pending outgoing mail (i.e. mail selected for sending since the last update of the local mail replica) to mail server 30 and requests from mail server 30 updates to incoming mail received by mail server 30 for this user since the last update of the user's local mail replica. Every time client e-mail program 27, while operating in the local replica mode, sends outgoing e-mails from workstation 20 to mail server 30, client e-mail program 27 makes an entry in a log 128 indicating the time and date of the update to the local mail replica 28. Likewise, every time client e-mail program 27, while operating in the local replica mode, receives from mail server 30 updates to the user's incoming e-mail (which includes new e-mail if any, received since the last update), client e-mail program 27 makes an entry in log 128 indicating the time and date of the update to the local mail replica 28.

The client e-mail program 27 also provides a user-selectable option to allow workstation 20 to directly access from mail server 30 the mail server's copy of the user's incoming and outgoing e-mail stored on the mail server 30 (and not maintain a local mail replica). Also, in this mode of operation, whenever a user generates and selects to send an e-mail, the user's workstation promptly sends the e-mail to its mail server (and the mail server promptly forwards the e-mail to the mail server of the addressee). In this mode of operation, there is no batching of incoming or outgoing e-mail. The foregoing features of client e-mail program 27 and server e-mail program 37 are prior art.

Client e-mail program 27 and server e-mail program 37 also assist an originator of an e-mail in completing the address of an addressee when the address is listed in a directory 38 and the originator supplies a distinguishing or significant part of the e-mail address of the addressee. For example, the directory 38 contains the following intra company e-mail address: “Thomas Robert Jones/Rochester/IBM@IBMUS” (although the client e-mail program works similarly for other types of e-mail addresses). If the originator of the e-mail enters “Thomas Robert Jo”, then the client e-mail system may determine from the directory that there is only one addressee listed which begins “Thomas Robert Jo”, and in response, complete the address for the e-mail, i.e. adds “nes/Rochester/IBM@IBMUS” to what was entered by the originator. This assists the originator in entering the address, and also confirms to the originator that this address is valid. The client e-mail program can also complete an address (entered in part by the originator of the e-mail) where there are two or more possible endings, by selecting the address that has been used recently by the originator or a list of selectable addresses, but permit the originator to overwrite it if incorrect. The client e-mail program can also suggest in a pull-down menu two or more possible e-mail addresses that correspond to what the originator entered, and permit the originator to select the correct one. At which time, the client e-mail program will enter the complete e-mail address in the address field. In all the foregoing scenarios, the client e-mail program needs access to the information in the directory 38, either from a local directory replica 122 or by query to remote mail server 30. If the user of the client workstation has enabled the local directory replica option and it is working, then the client e-mail program 27 periodically (for example, every hour) requests from mail server 30 updates to its local directory replica 122, and the mail server downloads the updates. In response, the client e-mail program 27 updates its local directory replica 122 and also notes the date/time of update in a log 124. However, if the user of the client workstation has not enabled the local directory option or it is enabled, but not working (i.e. not replicating), then the client e-mail program must query the mail server for the directory information as noted above. However, if the mail server is down or the network connection to the mail server is down, then the client e-mail program cannot assist the originator of an e-mail in completing an e-mail address or confirm that an e-mail address entered by the originator is valid. The foregoing features of client e-mail program 27 and server e-mail program 37 are prior art.

In accordance with the present invention, the management computer 40 sends to client workstation 20 a agent monitoring program 29 to check from a configuration file 121 if the workstation includes a client e-mail program, and if so, locate and read the logs 124 and 128. By way of example, the agent monitoring program 29 includes a script program (such as a Python™ script program) to load the agent program code, and the agent program interacts with the client e-mail program 27 using an API for program 27 and also interacts with the operating system 22. Next, the agent monitoring program 29 determines from log 128, the last date that the local mail replica 28 was been updated, and whether the last update was within a predetermined time window, such as two weeks. This avoids “false positives” when the client workstation 20 is configured for replicate mode, but the workstation 20 was turned-off for some days just prior to the agent monitoring program 29 checking logs 124 and 128 and noting the last replication date was during the prior use of the workstation 20. For example, if the owner of the workstation 20 was on vacation for one week and did not turn-on the workstation during that week, and immediately after returning from vacation and turning-on the workstation 20, the agent monitoring program 29 reads the logs 124 and 128 and notes that the last replication date was one week earlier. In such a case, the management program 49 will still conclude that the workstation 20 is operating in replicate mode and not send a “false-positive” notice to the owner to enable replication.

If the local mail replica has not been updated within the predetermined time window, then agent program 29 concludes that the workstation is not using a local mail replica or the local mail replica is not being updated periodically. If the local mail replica has been updated within the predetermined time window, then the agent program concludes that the workstation is using a local mail replica and the local mail replica is being updated periodically. Next, the agent program 29 reports its conclusion to the management program 49 in the management computer 40. In response, the management program 49 generates a report indicating whether workstation 20 (and other workstations, not shown, being managed by management computer 40), is using a local mail replica. If the user of workstation 20 is not using a local mail replica, management program 49 also notifies the user of workstation 20 and his or her manager that the user is not using a local mail copy, and sends to the user instructions for how to enable local mail replication at workstation 20. The agent program also determines from log 124, the last date that the local directory replica 122 has been updated, and whether the last update was within a predetermined time window, such as one week. If the local directory replica has not been updated within the predetermined time window, then agent program concludes that the workstation is not using a local directory replica with periodic update. If the local directory replica has been updated within the predetermined time window, then the agent program concludes that the workstation is using a local directory replica with periodic update. Next, the agent program 29 reports is conclusion to the management program 49 in the management computer 40. In response, the management program 49 generates a report indicating whether workstation 20 (and other workstations, not shown, being managed by management computer 40), is using a local directory replica. If the user of workstation 20 is not using a local directory replica, management program 49 also notifies the user of workstation 20 and his or her manager, and sends instructions to the user of workstation 20 how to enable local directory replication at workstation 20. In alternate embodiments of the present invention, the agent program determines if workstation 20 was inactive/turned-off during any part of this predetermined time window, in which case lack of replication during the predetermined time window may have been due to workstation 20 being inactive/turned-off and not due to disablement of replication. Consequently, if workstation 20 was inactive/turned-off during any part of this predetermined time window and replication did not occur during the predetermined time window, then the management program 49 will not determine or report that replication is disabled. Conversely, if replication occurred during the predetermined time window despite an inactive/turned-off state of workstation 20 during some part of the predetermined time window, management program 49 can still determine and report that replication is enabled.

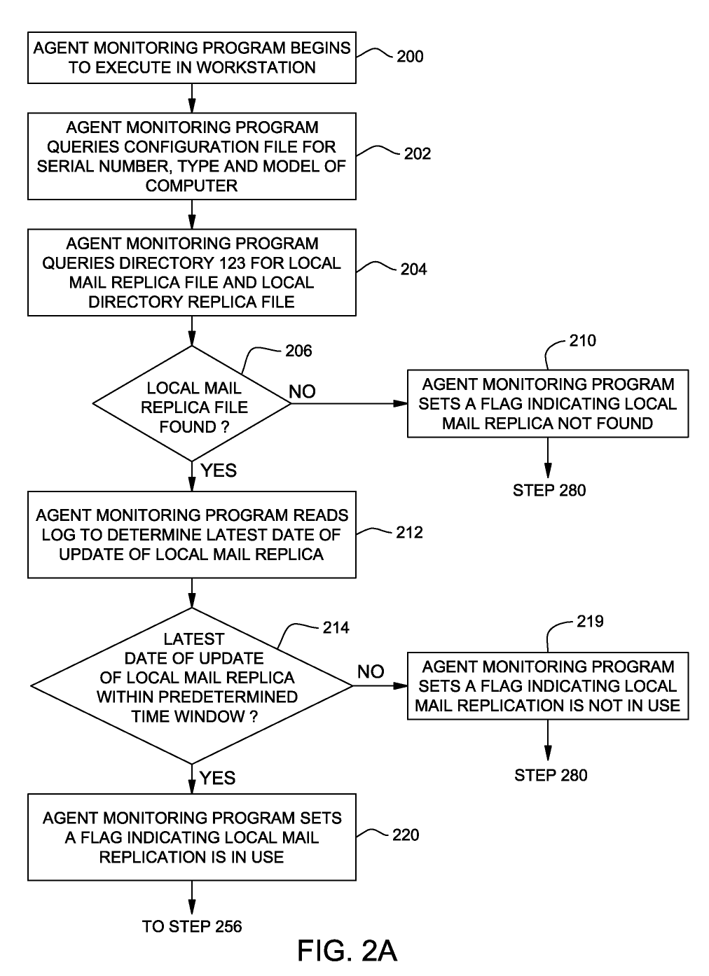

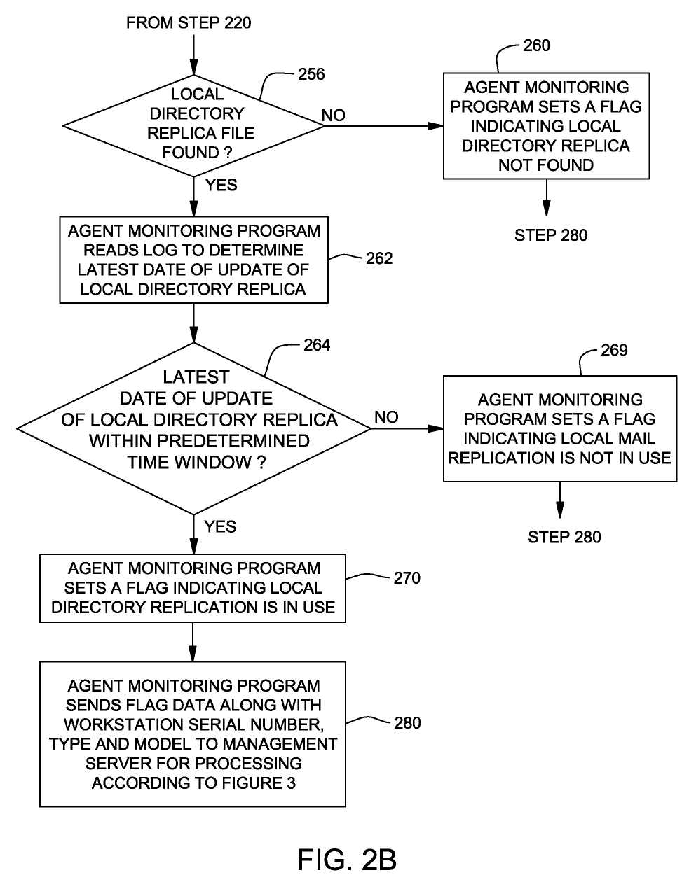

FIGS. 2(A) and 2(B) illustrate agent monitoring program 29 in more detail. To begin the process of monitoring local mail replica use and local directory replica use in workstation 20, management program 49 downloads agent program 29 to workstation 20 via Internet 30. In step 200, agent program 29 executes in workstation 20 and in step 202, agent program 29 queries a configuration file 121 for serial number, type and model of computer 20. Next, agent program queries a directory 123 for a list of program and data files that are installed in computer 20 (step 204). From directory 123 (or other directories or lists of programs within computer 20), agent program 29 looks for client e-mail program 29, local mail replica file 28 and local mail replica log 128, local directory replica file 122 and local directory replica log 124.

Agent program 29 first evaluates local mail replica usage, if any. If agent program 29 does not find local mail replica file 28 from the directory 123 (or other directory or list of programs within computer 20) (decision 206, no branch), then agent program 29 sets a flag indicating that local mail replication is not in use (step 210). However, if agent program 29 finds local mail replica file 28 (decision 206, yes branch), then agent program 29 checks the latest date of update of the local mail replica 28 from log 128 (step 212). Next, program 29 compares the latest date and time of update of the local mail replica 28 to a predetermined time window included with program 29 (decision 214) to determine if the local mail replica 28 has been updated recently enough (i.e. within the time window) to indicate that local mail replication is in properly use at workstation 20. However, if the local mail replica 28 has not been updated within the predetermined time window (decision 214, no branch), then program 29 sets a flag to indicate that local mail replication is not properly in use (step 219). However, if the local mail replica 28 has been updated within the predetermined time window (decision 214, yes branch), then program 29 sets another flag to indicate that local mail replication is properly in use (step 220).

Agent program 29 next evaluates local directory replica usage, if any. If agent program 29 does not find local directory replica file 122 (decision 256, no branch), then agent program 29 sets a flag indicating that local directory replication is not in use (step 260). However, if agent program 29 identifies local directory replica file 122 (decision 256, yes branch), then agent program 29 checks the latest date of update of the local directory replica 122 from log 124 (step 262). Next, program 29 compares the latest date and time of update of the local directory replica to a predetermined time window included with program 29 (decision 264) to determine if the local directory replica 122 has been updated recently enough (i.e. within the time window) to indicate that local directory replication is properly in use at workstation 20. If the local directory replica 122 has not been updated within the predetermined time window (decision 264, no branch), then program 29 sets a flag to indicate that local directory replication is not properly in use (step 269). However, if the local directory replica 122 has been updated within the predetermined time window (decision 264, yes branch), then program 29 sets another flag to indicate that local directory replication is properly in use (step 270).

Next, agent program 29 sends its data, i.e. which flags have been set, along with the serial number, type and model of workstation 20, to management computer 40, to indicate whether local mail replication is properly in use and whether local directory replication is properly in use in workstation 20 (step 280).

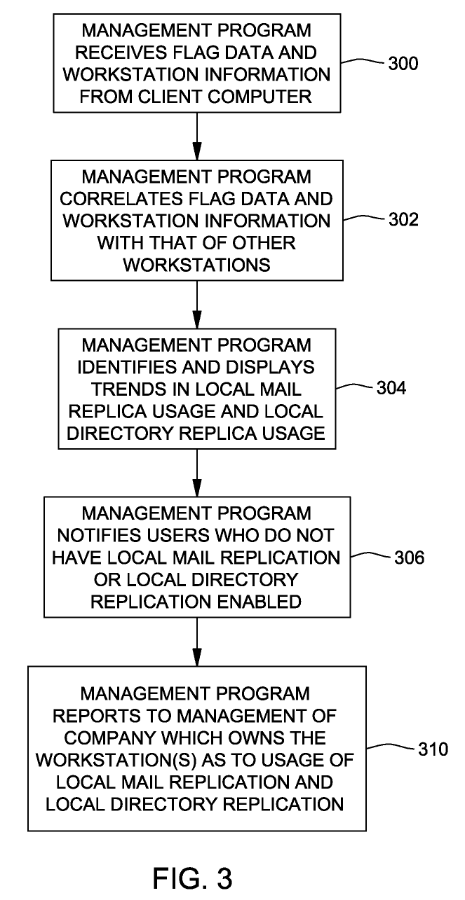

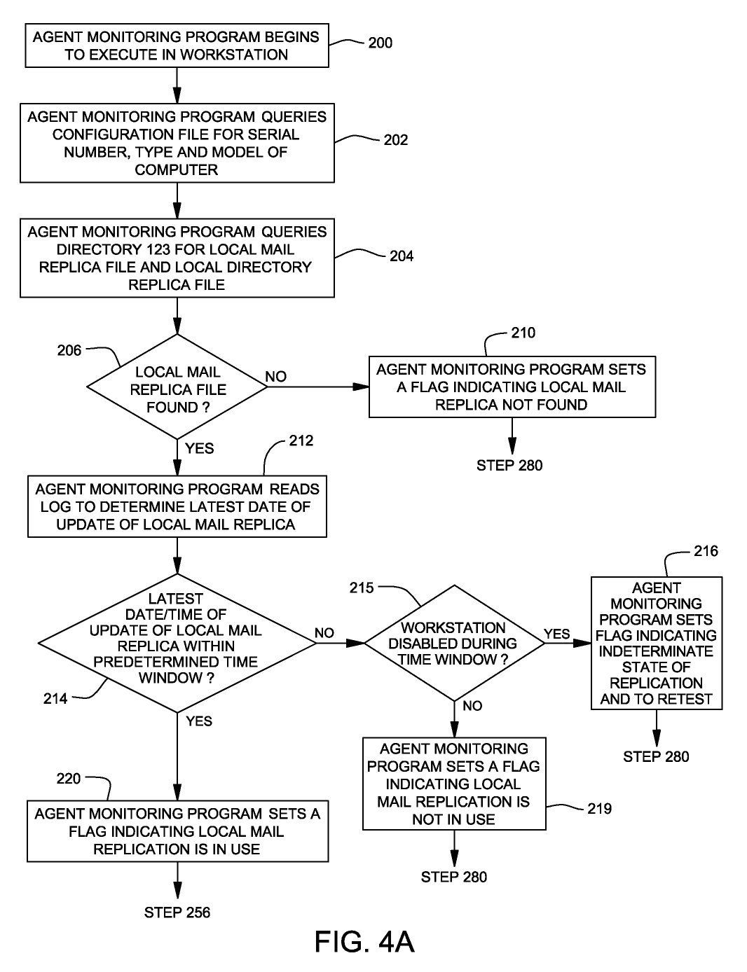

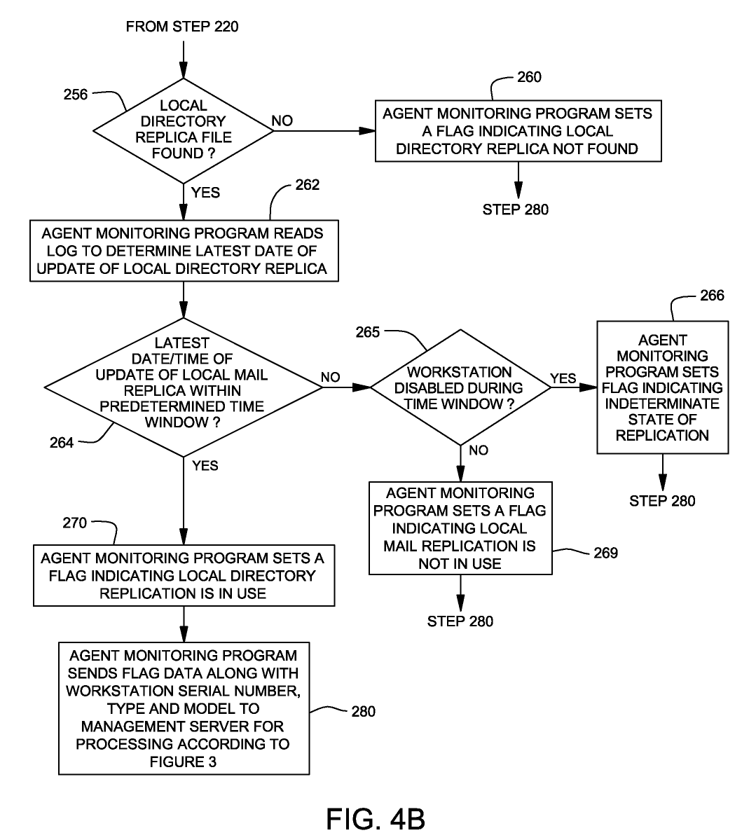

FIG. 3 illustrates subsequent processing by management program 49 in management computer 40. In step 300, program 49 receives the data sent by agent program 29. Next, program 49 correlates the computer serial number, type and model to the company (which presumably employs the user) or other entity which owns the workstation, and merges the data for workstation 20 with similar data received from similar agent programs in other workstations (step 302). Next, program 49 identifies trends from the data such as the percentage of users with local mail replication in use and percentage of users with local directory replication in use, both plotted separately as a function of time (step 304). This can be plotted (over time) per department in the company. Also, as program 49 sends notifications to the users who have not enabled local mail replication or local directory replication, program 49 can plot the change (presumably increase) in usage of local mail replication and local directory replication resulting from these notifications (step 306). The note will instruct each such user to enable local mail replication and local directory replication, as the case may be, and provide instructions how to enable local mail replication and local directory replication as the case may be. Next, program 49 reports to management of the company, if any, which owns workstation 20 and the other workstations, the identities of the workstations which do not have local mail replication or local directory replication properly in use (step 310).

FIGS. 4(A) and 4(B) illustrate an alternate embodiment of the agent monitoring program 29 which is similar to the embodiment illustrated in FIGS. 2(A) and 2(B) except the embodiment of FIGS. 4(A) and 4(B) includes decision 215 and step 216 to modify processing of the local mail replica log 128 data and decision 265 and step 266 to modify processing of the local directory replica log 124. In the embodiment illustrated in FIGS. 4(A) and 4(B), agent program 29 checks a system log 125, maintained by operating system 22, to determine if workstation 20 was inactive/turned-off during any part of the predetermined time windows for local mail replication and local directory replication. If workstation 20 was inactive/turned-off during any part of the respective predetermined time window, lack of replication during the predetermined time window may have been due to workstation 20 being inactive/turned-off and not due to disablement of replication. Consequently, if workstation 20 was inactive/turned-off during any part of this predetermined time window and replication did not occur during the predetermined time window, then the management program 49 will set a flag indicating that use of replication is indeterminate. In this alternate embodiment of the present invention, the predetermined time window is typically one hour or less (commensurate with typical replication periods). Consequently, if the workstation 20 was recently turned-on, i.e. less than the duration of the predetermined time window, and replication is enabled but has not occurred yet, then management program 49 will ignore the last replica dates of files 28 and 122 because lack of replication within the predetermined time window may be due to workstation 20 being in the off state (in which replication never occurs) and not lack of enabling of the replication option. This avoids “false positives” while permitting the predetermined time window to be short. If workstation 20 was inactive during the predetermined time window, then agent monitoring program 29 repeats the processing of FIGS. 4(A) and 4(B) after one predetermined time window commencing from the date and time that the workstation 20 was turned-on. Management program 49 can defer reporting of the use of replication at workstation 20 until the processing of FIGS. 4(A) and 4(B) has been repeated as explained above.

Consider first the addition of decision 215 and step 216 of FIG. 2(A) to modify processing of the local mail replication date/time. After determining that the last date/time of local mail replication was not within the respective predetermined time window (decision 214, no branch), agent monitoring program 29 checks system log 125 to determine how long workstation 20 has been active/turned-on. If workstation 20 was inactive/turned-off during any part of this predetermined time window (decision 215, yes branch), lack of local mail replication during the predetermined time window may have been due to workstation 20 being inactive/turned-off and not due to disablement of local mail replication. Consequently, if workstation 20 was inactive/turned-off during any part of this predetermined time window (decision 215, yes branch) and local mail replication did not occur during the predetermined time window (decision 214, no branch), then agent monitoring program 29 sets a flag indicating that enabling of local mail replication is indeterminate (step 216). Agent monitoring program 29 will report this indeterminate flag in step 280 along with the other flag data, and management program 49 will not determine or report that local mail replication is enabled or disabled in steps 306 and 310. Optionally, management program 49 can report that enabling of local mail replication is indeterminate. However, if local mail replication occurred during the predetermined time window despite an inactive/turned-off state of workstation 20 during some part of the predetermined time window (decision 214, yes branch), agent monitoring program 29 will still set the flag indicating that local mail replication is enabled (step 220) and management program 49 will still determine and report that local mail replication is enabled in steps 306 and 310.

Consider next the addition of decision 265 and step 266 of FIG. 2(A) to modify processing of the local directory replication date/time. After determining that the last date/time of local directory replication was not within the respective predetermined time window (decision 264, no branch), agent monitoring program 29 checks system log 125 to determine how long workstation 20 has been active/turned-on. If workstation 20 was inactive/turned-off during any part of this predetermined time window (decision 265, yes branch), lack of local directory replication during the predetermined time window may have been due to workstation 20 being inactive/turned-off and not due to disablement of local directory replication. Consequently, if workstation 20 was inactive/turned-off during any part of this predetermined time window (decision 265, yes branch) and local directory replication did not occur during the predetermined time window (decision 264, no branch), then agent monitoring program 29 sets a flag indicating that enabling of local directory replication is indeterminate (step 266). Agent monitoring program 29 will report this indeterminate flag in step 280 along with the other flag data, and management program 49 will not determine or report that local directory replication is enabled or disabled in steps 306 and 310. Optionally, management program 49 can report that enabling of local directory replication is indeterminate. However, if local directory replication occurred during the predetermined time window despite an inactive/turned-off state of workstation 20 during some part of the predetermined time window (decision 264, yes branch), agent monitoring program 29 will still set the flag indicating that local directory replication is enabled (step 270) and management program 49 will still determine and report that local directory replication is enabled in steps 306 and 310.

Program 29 can be loaded into computer 20 from a computer readable media 129 such as magnetic tape or disk, optical media, DVD, memory stick, semiconductor memory, etc. or downloaded from Internet 130 via TCP/IP adapter card 126.

Program 49 can be loaded into computer 40 from a computer readable media 149 such as magnetic tape or disk, optical media, DVD, memory stick, semiconductor memory, etc. or downloaded from Internet 130 via TCP/IP adapter card 146.

Based on the foregoing, a system, method and program product for monitoring usage of a local mail replication and local directory replication and taking corrective action have been disclosed. However, numerous modifications and substitutions can be made without deviating from the scope of the present invention. For example, the client workstation 20 can require other types of data files, and either fetch the file data dynamically as needed from server 30 or maintain a local replica of the data files. To reduce burden on the server and the intervening network, it may be desirable for the workstation 20 to maintain a local replica of these data files. The present invention (management program 49, agent monitoring program 29 and logs which record the last date of update of the data files) can be used to determine whether replication is in use for these data files. Therefore, the present invention has been disclosed by way of illustration and not limitation, and reference should be made to the following claims to determine the scope of the present invention.

What is claimed:

1. A computer program product for monitoring use of a local file replica in a client computer, said computer program product comprising:
a computer readable media;
first program instructions to read a log which records a date and/or time of last replication of the local file replica from a remote file server;
second program instructions to compare the date and/or time of last replication of said local file replica to a predetermined time window; and
third program instructions, responsive to said date and/or time of last replication of said local file replica being within said predetermined time window, to determine and report that local file replication is currently in use, and responsive to said date and/or time of last replication of said local file replica being outside said predetermined time window, to determine and report that local file replication is not currently in use; and wherein
said first, second and third program instructions are stored on said media in functional form.

2. A computer program product as set forth in claim 1 wherein replication of said local file replica does not occur while said client computer is turned-off even if replication is enabled, and said third program instructions determine how long said client computer has been turned-on, and is responsive to said date and/or time of last replication of said local file replica being outside said predetermined time window, to not determine or report that local file replication is not currently in use or report that local file replication is indeterminate.

3. A computer program product as set forth in claim 1 wherein said third program instructions also determine and report trends in usage of local file replication after each of a plurality of reports of local file replication.

4. A computer program product as set forth in claim 1 wherein said local file replica is a local mail replica and said remote file server is a remote mail server.

5. A computer program product as set forth in claim 2 wherein said local file replica is a local mail replica and said remote file server is a remote mail server.

6. A computer program product as set forth in claim 1 wherein said local file replica is a local directory replica and said remote file server is a remote directory server.

7. A computer program product as set forth in claim 2 wherein said local file replica is a local directory replica and said remote file server is a remote directory server.

8. A computer system for monitoring use of a local file replica in a client computer, said computer system comprising:
means for reading a log which records a date and/or time of last replication of the local file replica from a remote file server;
means for comparing the date and/or time of last replication of said local file replica to a predetermined time window; and
means, responsive to said date and/or time of last replication of said local file replica being within said predetermined time window, for determining and reporting that local file replication is currently in use, and responsive to said date and/or time of last replication of said local file replica being outside said predetermined time window, for determining and reporting that local file replication is not currently in use.

9. A computer system as set forth in claim 8 wherein replication of said local file replica does not occur while said client computer is turned-off even if replication is enabled, and the determining means determine how long said client computer has been turned-on, and is responsive to said date and/or time of last replication of said local file replica being outside said predetermined time window, to not determine or report that local file replication is not currently in use or report that local file replication is indeterminate.

10. A computer system as set forth in claim 8 wherein said determining means also determines and reports trends in usage of local file replication after each of a plurality of reports of local file replication.

11. A computer system as set forth in claim 8 wherein said local file replica is a local mail replica and said remote file server is a remote mail server.

12. A computer system as set forth in claim 9 wherein said local file replica is a local mail replica and said remote file server is a remote mail server.

13. A computer system as set forth in claim 8 wherein said local file replica is a local directory replica and said remote file server is a remote directory server.

14. A computer system as set forth in claim 9 wherein said local file replica is a local directory replica and said remote file server is a remote directory server.

15. A method for monitoring use of a local file replica in a client computer, said method comprising the steps of:
reading a log which records a date and/or time of last replication of the local file replica from a remote file server;
comparing the date and/or time of last replication of said local file replica to a predetermined time window; and
determining whether local file replication is currently in use based on whether said date and/or time of last replication of said local file replica is within said predetermined time window.

16. A method as set forth in claim 15 wherein replication of said local file replica does not occur while said client computer is turned-off even if replication is enabled, and further comprising the steps of:
determining that said client computer has not been turned-on for all of said predetermined time window, and if said date and/or time of last replication of said local file replica is outside said predetermined time window, determining that local file replication is indeterminate.

17. A method as set forth in claim 15 wherein said local file replica is a local mail replica and said remote file server is a remote mail server.

18. A method as set forth in claim 16 wherein said local file replica is a local mail replica and said remote file server is a remote mail server.

19. A method as set forth in claim 15 wherein said local file replica is a local directory replica and said remote file server is a remote directory server.

20. A method as set forth in claim 16 wherein said local file replica is a local directory replica and said remote file server is a remote directory server.
